(19) United States
(12) Patent Application Publication
(10) Pub. No.: US 2021/0039990 A1
(43) Pub. Date: Feb. 11, 2021

(54) PLATE-SHAPED, CHEMICALLY PRESTRESSED OR CHEMICALLY PRESTRESSABLE GLASS ARTICLES, AND METHODS OF PRODUCING

(71) Applicant: SCHOTT AG, Mainz (DE)

(72) Inventors: Sebastian Leukel, Mainz (DE); Thomas Seuthe, Jena (DE); Jochen Alkemper, Klein-Winternheim (DE); Julia Weißhuhn, Mainz (DE); Oliver Hochrein, Mainz (DE)

(73) Assignee: SCHOTT AG, Mainz (DE)

(21) Appl. No.: 16/986,203

(22) Filed: Aug. 5, 2020

(30) Foreign Application Priority Data
Aug. 5, 2019 (DE) 10 2019 121 143.3

(51) Int. Cl. C03C 21/00; C03C 4/18; C03C 3/083; C03C 3/085; C03C 3/087; C03C 3/091; C03C 3/093; C03C 3/097

(52) U.S. Cl. CPC C03C 21/002; C03C 4/18; C03C 3/083; C03C 3/085; C03C 2204/00; C03C 3/091; C03C 3/093; C03C 3/097; C03C 3/087

(57) ABSTRACT

A chemically prestressed or chemically prestressable, plate-shaped or disc-shaped glass article is provided. The glass article includes a glass with a composition of Al₂O₃, SiO₂, Na₂O, and Li₂O and a prestressing or a prestressability in relation to the weight percent of Na₂O of at least 250 MPa/g Na₂O in 100 g of glass. The Na₂O is present in a weight percent between at least 0.8 and at most 6.

### CROSS REFERENCE TO RELATED APPLICATIONS

This application claims benefit under 35 USC § 119 of German Application No. 10 2019 121 143.3 filed Aug. 5, 2019, the entire contents of which are incorporated herein by reference.

### BACKGROUND

### 1. Field of the Invention

The invention relates to a plate-shaped, chemically prestressed or at least chemically prestressable glass article and to a method for the production thereof. Furthermore, the present disclosure also relates to a glass composition.

### 2. Description of Related Art

Plate-shaped prestressed, in particular chemically prestressed and especially chemically highly prestressed glass articles find use, in particular, as so-called protective glasses (or covers or cover glasses) for mobile devices such as smartphones or tablet computers. In comparison to covers made of transparent plastics, these protective glasses are, in particular, more scratch-resistant, but they do also have a greater weight.

Only chemically prestressed, plate-shaped glass articles find a use as protective glasses for mobile devices, since these glass articles are again more resistant toward mechanical wear loads; that is, they exhibit the resistance to wear required for the application in question. In the context of the present disclosure, wear resistance is understood to mean the resistance of a product (or article, such as a glass article or a glass product) toward mechanical loads, in particular toward abrasive loads, scratch loads, or impact loads. The term wear resistance or, in short, strength, is thus used in the context of the present disclosure as a general term for the mechanical resistance of a product or article. Special forms of wear resistance or, in short, strength, are, for example, the scratch resistance, the flexural strength, and the impact strength and it has been found that these loads can also be linked to one another and such links are of special relevance especially in practical application. Such practical loads are, for example, impact on a rough surface, in particular in an installed state.

Besides the requirements placed on a good wear resistance, however, the plate-shaped glass article should also meet further requirements. In particular, the glass comprised by the glass article should be easy to produce; that is, it should be amenable to a melting process followed by a hot shaping process, during which devitrification should preferably not occur. The chemical resistance of the glass article is also of relevance, in particular its resistance to acids. This is to be regarded, in particular, against the background that, although a good resistance of the final product is necessary, a good prestressability in an ion exchange process also needs to be given, on the other hand.

Chemically prestressable glasses and/or chemically prestressable or chemically prestressed glass articles and/or methods for producing such articles are known.

Chemically prestressable glasses can be differentiated into so-called aluminum silicate glasses (also referred to as AS glasses, alumosilicate glasses, or aluminosilicate glasses), which comprise as components, in particular, Al₂O₃ and SiO₂ as well as alkali oxides, except for lithium oxide Li₂O, as well as lithium aluminum silicate glasses (also referred to as LAS glasses, lithium alumosilicate glasses, or lithium aluminosilicate glasses), which, furthermore, additionally comprise Li₂O as a component.

These glasses are designed in such a way that they can be chemically prestressed. A glass that can be chemically prestressed is understood in the context of the present disclosure to mean a glass that is amenable to an ion exchange process. In such a process, ions of alkali metals are exchanged in a surface layer of a glass, such as, for example, a glass plate or disc. This occurs in such a way that a zone of compressive stress is then built up in the surface layer, this being brought about by the exchange of ions having small radii with ions having larger radii. For this purpose, the glass article is immersed in a so-called ion exchange bath, such as, for example, a molten salt, where the ion exchange bath comprises the ions having the larger ionic radii, in particular potassium ions and/or sodium ions, so that these ions migrate into the surface layer of the glass article. In exchange therefor, ions having smaller ionic radii, in particular lithium ions and/or sodium ions, migrate out of the surface layer of the glass article into the ion exchange bath.

In this way, a zone of compressive stress is formed. This zone of compressive stress can be described by the characterizing values of compressive stress, which is abbreviated as “CS,” and the depth of compressive stress, which is also referred to as “depth of layer” or, abbreviated, “DoL.” This depth of compressive stress DoL is well known to the person skilled in the art and, in the context of the present disclosure, refers to the depth at which the stress curve has the stress zero-crossing. Alternatively or additionally, this thickness DoL can be determined by means of an optical zero-crossing stress measurement method, such as, for example, by means of a measuring instrument with the trade name FSM-6000 or SLP 1000.

It is also possible by means of this measuring instrument to measure the compressive stress of the surface of aluminosilicate glasses as well as the maximum compressive stress CS of a plate or of a plate-shaped glass article.

The known glasses of the prior art hereby generally have a high content of alkali oxides as components. This has hitherto been regarded as being necessary in order to make it possible to design a glass article to be prestressable to high compressive stresses. At the same time, a high content of alkali oxides leads to a lowering of the melt temperature.

However, there are conflicting goals here. Thus, although the prestressable glasses of the prior art can, as a rule, be readily melted and are amenable to an ion exchange, it has been found that, on the one hand, long immersion times are necessary in order to create the desired high compressive prestresses at the surface of the glass article. On the other hand, a high content of alkali oxides is unfavorable, in principle, in regard to the chemical resistance, such as, for example, the resistance of the glass article to hydrolysis and/or to acids.

Therefore, there is a need for plate-shaped glass articles that are designed to be chemically highly prestressable and here, at the same time, to be readily melted and that exhibit an acid resistance. In a corresponding way, there is a need for chemically prestressed, plate-shaped glass articles with high compressive prestress and preferably, at the same time, a good resistance to acids.

### SUMMARY

The object of the invention consists in providing plate-shaped glass articles, in particular chemically prestressable or chemically prestressed plate-shaped glass articles, which at least alleviate the drawbacks of the prior art.

In accordance with a first aspect, the present disclosure thus relates to a chemically prestressed or at least chemically prestressable, plate-shaped glass article that comprises a glass with a composition comprising Al₂O₃, SiO_{2,} Na₂O, and preferably Li₂O and having preferably at least one of the following features: The glass comprises at most 6 wt % Na₂O, preferably at most 5.5 wt % Na₂O, especially preferably at most 4.5 wt % Na₂O, and preferably at least 0.8 wt % Na2O and/or The glass article has a prestress or at least a prestressability, CS, in relation to the weight percent of Na₂O in the glass article, of at least 250 MPa/g Na₂O in relation to an amount of 100 g of glass. Preferably, the prestressability is at most 1500 MPa/g Na₂O, especially preferably at most 1000 MPa/g Na₂O, in relation to an amount of 100 g of glass.

Such a design of a glass article has a number of advantages.

As a result of the design of the glass article so that it comprises a glass with a composition comprising Al₂O₃, SiO₂, and Na₂O, the plate-shaped glass article is designed, first of all, to be chemically prestressable, since what is involved here in the case of the glass comprising the glass article is an AS glass or even a LAS glass. Preferably, namely, the glass article is designed such that the glass comprising the glass article comprises Li₂O. As is known, such AS and LAS glasses are amenable to a chemical hardening or to a chemical prestressing by way of an ion exchange.

In this embodiment, the glass comprises at most 6 wt %, preferably at most 5.5 wt % Na₂O, especially preferred also only at most 4.5 wt % Na₂O. A low content of the alkali oxide Na₂O is especially advantageous in regard to the resistance to acids, since alkali oxides can be leached out of a glass, whereby, due to the smaller field strength of the sodium ion, in comparison to a lithium ion, for example, it is more readily leachable. Therefore, the Na₂O content is limited.

The low content in the glass and, in a corresponding way, in the glass article comprising the glass is advantageous against the background of producing the glass article, in particular during chemical prestressing. Since the glass comprises little Na₂O, there is also only little poisoning of the exchange bath due to sodium ions migrating out of the glass into the exchange bath. This is therefore advantageous in regard to the economy of the production method.

However, the glass or the glass article comprising the glass has a minimum content of Na₂O. This is necessary in order for the glass to be amenable to an ion exchange and, in particular, to a so-called potassium exchange. Moreover, in this way, the meltability of the glass is improved. Preferably, the glass or the glass article comprises at least 0.8 wt % Na₂O.

It is surprising, however, that, with such a low Na₂O content of at least only 0.8 wt %, nonetheless good compressive prestresses can be achieved. In particular, on account of the potassium exchange, compressive prestresses (CS) of at least 600 MPa and of up to 1000 MPa are achieved.

Alternatively or additionally, the glass article is designed in such a way that it has a prestress or at least a prestressability, in relation to the weight percent of Na₂O in the glass or in the glass article, of at least 250 MPa/g Na₂O in relation to an amount of 100 g of glass. Preferably, the prestressability is at most 1500 MPa/g Na₂O, especially preferred at most 1000 MPa/g Na₂O, in relation to an amount of 100 g of glass.

In other words, the glass or the glass article is designed in this case in such a way that it has a large stress in relation to the sodium oxide comprised by the glass or glass article.

### BRIEF DESCRIPTION OF THE FIGURES

The invention will be explained in detail below on the basis of drawings. Shown are:

FIG. 1 is a schematic and not dimensionally accurate illustration of a glass article in accordance with the presently disclosed embodiments;

FIG. 2 is a schematic and not dimensionally accurate sectional image through a glass article in accordance with the presently disclosed embodiments.

### DETAILED DESCRIPTION

In the context of the present disclosure, prestressability is understood to mean the ability of a glass or of a glass article to be highly prestressed, in particular the ability of taking up and storing stresses that are introduced. In the context of the present disclosure, high prestresses refer to prestresses that are at least 400 MPa.

It has hitherto been assumed that a large absolute amount of alkali ions comprised by the glass or by the glass article is necessary in order for the glass or for the glass article comprising the glass to be readily prestressable or in order to achieve a high chemical prestress of the glass article of at least 400 MPa or preferably at least 600 MPa, in particular for glass thicknesses of at least 0.4 mm and of up to 3 mm. Surprisingly, however, it has been found that, with only low contents of the alkali ion to be exchanged, it is possible to ensure good prestressabilities.

Two aspects seem hereby worthy of note:

Thus, a low absolute content of the alkali ion that is to be exchanged, that is, in particular the sodium ion in this case, is still able to lead to an adequate prestress and even to a high prestress of at least 600 MPa and of even up to 1000 MPa, in particular for glass articles with glass thicknesses from at least 0.4 mm up to 3 mm, when the alkali ions, in particular the sodium ions, are readily amenable to an ion exchange. The first aspect thus relates to the exchangeability of the alkali ions comprised by the glass or by the glass article. The inventors are of the opinion that prestresses even higher than 1000 MPa can be achieved.

Alternatively or additionally, however, the prestressability of the glass matrix is also significant. This means that a high exchangeability of the alkali ions that are to be exchanged is not or not only or not solely significant, but rather also the ability of the glass matrix to build up and/or to store a prestress is significant.

If both prerequisites are met, that is, when a large proportion of the alkali ions comprised by the glass is readily amenable to an exchange and, at the same time, the glass matrix is designed to build up and/or store a high prestress, even a possibly absolutely low proportion of alkali ions to be exchanged may be sufficient in order to obtain, nonetheless, a chemically highly prestressable or chemically prestressed glass article.

In the context of the present disclosure, the following definitions apply:

An exchange bath is understood to mean a molten salt that is employed in an ion exchange method for a glass or for a glass article. In the context of the present disclosure, the terms exchange bath and ion exchange bath are used synonymously.

As a rule, salts of technical-grade purity are used for exchange baths. This means that, in spite of the use of solely sodium nitrate, for example, as the starting material for an exchange bath, certain contaminants are still present in the exchange bath. The exchange bath is here a melt of a salt, such as, for example, sodium nitrate, or a melt of a mixture of salts, such as, for example, a mixture of a sodium salt and a potassium salt. In this case, the composition of the exchange bath is present in the form that relates to the nominal composition of the exchange bath without taking into consideration possibly present contaminants. Therefore, in the context of the present disclosure, insofar as a 100% sodium nitrate melt is indicated, this therefore means that, as raw material, solely sodium nitrate was used. However, the actual content of sodium nitrate in the exchange bath can deviate from this and, as a rule, does so, because, in particular, technical-grade raw materials have a certain proportion of contaminants. However, as a rule, these contaminants constitute less than 5 wt % in relation to the total weight of the exchange bath, in particular less than 1 wt %.

In a corresponding way, in the case of exchange baths that have a mixture of different salts, the nominal contents of these salts are presented without taking into consideration technically caused contaminants of the starting materials. An exchange bath containing 90 wt % KNO₃ and 10 wt % NaNO₃ can therefore also still have small amounts of contaminants, which, however, are due to raw materials and, as a rule, should constitute less than 5 wt % in relation to the total weight of the exchange bath, in particular less than 1 wt %.

Furthermore, the composition of the exchange bath also changes in the course of the ion exchange, because, owing to the progressing ion exchange, particularly lithium ions migrate out of the glass or out of the glass article into the exchange bath. However, such a change in the composition of the exchange bath due to aging is also not taken into consideration in the present case, insofar as it is not explicitly stated otherwise. Instead, in the context of the present disclosure, the nominal original composition is taken into account in stating the composition of an exchange bath.

A stress profile is understood in the context of the present disclosure to mean the plot in a diagram of the stress in a glass article, such as, for example, in a glass plate, versus the thickness of the glass in question. Insofar as, in the context of the present disclosure, a compressive stress profile is addressed, this is understood here to mean the part of a stress profile in which the stress takes on positive values, that is, is greater than zero. In contrast, tensile stress has a negative sign. What is involved thereby is the definition of the sign of the stress as it is conventionally used by the person skilled in the art, that is, the developer of prestressed protective glasses, in regard to the sign of the stress. This differs especially from the usual reference to the compressive stress as negative and the tensile stress as positive, such as, for example, as conventionally assumed in physics. In the context of the present disclosure, however, recourse is made here, as discussed, to the definition of stresses as conventionally used in the glass industry.

A combined compressive stress profile is understood in the context of the present disclosure to mean a compressive stress profile for which the compressive stress in the corresponding article, such as a glass article, is combined from at least two subregions.

The compressive stress stored in a prestressed glass article is obtained by integration of the compressive stress over the thickness of the glass article. In the context of the present disclosure, this integral is referred to as the compressive stress integral.

The tensile stress stored in a prestressed glass article is obtained by the integration of the tensile stress over the thickness of the glass article. In the context of the present disclosure, this integral is referred to as the tensile stress integral. In the context of the present disclosure, the terms: stored tensile stress and tensile stress integral are therefore also used synonymously.

A plate-shaped glass article is understood in the context of the present disclosure to mean a glass article for which the lateral dimension in one spatial direction is at least an order of magnitude less than that in the two other spatial directions, whereby these spatial directions are given with respect to a Cartesian coordinate system, in which these spatial directions extend perpendicular to one another and the thickness in the direction of the normal to the largest or main surface is hereby measured from the one main surface to the other main surface.

Because the thickness is at least an order of magnitude less than the width and length of the glass article, the width and length can thereby be of the same order of magnitude. However, it is also possible that the length is again markedly greater than the width of the glass article. In the sense of the present disclosure, plate-shaped glass articles can therefore comprise a glass ribbon.

In the sense of the present disclosure, a glass is understood to mean a material and a glass article is understood to mean a product that is produced from the material glass and/or the product comprising the material glass. In particular, a glass article can be composed of glass or predominantly contain, that is, up to at least 90 wt %, the material glass.

A chemical prestressing in the context of the present disclosure is understood to mean a process in which a glass article is immersed in a so-called exchange bath, resulting in an exchange of ions. A potassium exchange is understood in the sense of the present disclosure to mean that potassium ions migrate out of the exchange bath into the glass article, in particular into the surface of the glass article; that is, for example, they are incorporated into the surface of the glass article, whereby, at the same time, small alkali ions, such as, for example, sodium ions, migrate out of the glass article into the exchange bath. A sodium exchange is understood in a corresponding way to mean that sodium ions migrate out of the exchange bath into the surface of the glass article, whereas small ions, such as, for example, lithium ions, migrate out of the glass article, in particular out of the surface of the glass article, into the exchange bath. As already described, this ion exchange results in the buildup of a zone of compressive stress in the surface region of the glass article.

The maximum tensile stress is understood in the context of the present disclosure to mean the minimum stress value in the stress profile of a glass article.

A so-called “sharp impact” is understood in the context of the present disclosure to mean a load for which the damage is produced by a small sharp object or by a large number of such small sharp objects. In other words, what is involved is therefore an impact with one sharp object or a plurality of sharp objects, that is, for example, with particles that have very small radii of curvature or for which the angle of the tip of the particle is less than 100°.

Insofar as, in the context of the present disclosure, reference is made to the grit of an abrasive paper, this grit is given taking into account and preferably in accord with DIN ISO 6344. This grit is oriented to mesh as a unit of measurement. The larger the grit, the smaller are thereby the abrasive particles. In the context of the present disclosure, the terms “grit 60” and “#60”—here, for example, in relation to a so-called grit of 60—are used synonymously in referring to the grit. This obviously applies in a corresponding way to other grits, such as, for example, a 100 or 180 grit.

In the context of the present disclosure, the term field strength of an ion is used in accordance with Dietzel. In particular, this term is used in relation to an oxidic glass matrix, with it being understood that this value can change depending on the coordination number of the ion in question.

In regard to the terms network modifier and network former, these terms are understood in accordance with Zachariasen.

In the context of the present disclosure, network formers hereby refer, in particular, to SiO₂, Al₂O₃, B₂O₃, and P₂O₅.

Network modifiers refer, in particular, to alkali oxides and alkaline earth oxides.

In particular, ZrO₂ is referred to as a so-called intermediate oxide.

A glass in accordance with embodiments of the present disclosure or a plate-shaped, chemically prestressable or chemically prestressed glass article in accordance with embodiments of the present disclosure can also be designed, in particular, in such a way that it comprises at most 6 wt % Na₂O, preferably at most 5.5 wt % Na₂O, especially preferably at most 4.5 wt % Na₂O, where the minimum amount of Na₂O is preferably at least 0.8 wt %, where the glass article has a prestress or at least a prestressability, in relation to the weight percent of Na₂O in the glass or in the glass article, of at least 250 MPa/g Na₂O in relation to an amount of 100 g of glass. Preferably, the prestressability is at most 1500 MPa/g Na₂O, especially preferred at most 1000 MPa/g Na₂O, in relation to an amount of 100 g of glass.

In this way, in an especially advantageous manner, preferably a good resistance of the glass or glass article is obtained, whereby the glass article is formed in a chemically highly prestressed manner or in a chemically highly prestressable manner.

The reason is not yet entirely understood why, with even an only very small content of Na₂O in the glass or in the glass article, nonetheless a high chemical prestressing can be achieved or is achieved. However, it is thought that the reason for this lies in a targeted adjustment of the glass matrix or of the glass network.

In accordance with an embodiment of the glass article, the glass comprises the further composition percentages given in the context of the present disclosure, but at least 57 wt % SiO₂, preferably at least 59 wt % SiO₂, especially preferred at least 61 wt % SiO₂, and/or the glass comprises at most 69 wt % SiO₂, preferably at most 67 wt %.

As a glass constituent, SiO₂ is a so-called network former. A high proportion of SiO₂ in a glass increases the chemical resistance of the glass, in particular the resistance to acids, and is therefore advantageous. It is also known that quartz glass SiO₂ forms a very rigid, three-dimensionally cross-linked glass network. In accordance with one embodiment of the glass or of the glass article, therefore, the content of SiO₂, with the otherwise further presently disclosed constituents of the composition, is at least 57 wt %, preferably even at least 59 wt% SiO₂, and especially preferred at least 61 wt % SiO₂. However, too high a content of SiO₂ results in the glass being only poorly meltable.

For this reason, in accordance with the presently disclosed embodiments, the content SiO₂ in the glass is limited and is at most 69 wt %, preferably at most 67 wt %.

As a glass constituent, Al₂O₃, like SiO₂, is a network former. A minimum content of Al₂O₃ within the above-mentioned limits in the glasses and in the glass articles in accordance with embodiments is advantageous, since the addition of Al₂O₃ results in a reduction in the number of non-bridging oxygens in an alkali-containing silicate glass, so that, in spite of a certain content of a glass, a rigid network can be obtained. It has been found that the formation of a relatively rigid glass network is favorable for the prestressability of an alkali-containing glass.

However, in accordance with one embodiment, the content of Al₂O₃ in the glass or in the glass article is also limited along with the further constituents of the composition otherwise given in the context of the present disclosure, since, in too large amounts, Al₂O₃ leads to a decline in the resistance of the glass to acids in particular. Therefore, in accordance with this embodiment, the content of Al₂O₃ in the glass or in the glass article is preferably at least 17 wt % and/or at most 25 wt %, preferably at most 24 wt % and especially preferred at most 21 wt %.

It has been found overall that an especially good prestressability of the glass or of the glass article or an especially high chemical prestressing, in particular in relation to the weight percent of Na₂O in the glass or in the glass article, can be obtained by way of a high content of network formers in the glass or in the glass article, in particular by way of a high content of the network formers SiO₂ and Al₂O₃ in the glass. In accordance with preferred embodiments of the glass or of the glass article, the content of network formers in the glass or in the glass article is, in each case, at least 82 wt % and/or is equal to a sum of the content of Al₂O₃ and SiO₂ in the glass or in the glass article of at least 75 wt %. This high content of network formers in the glass or in the glass article, in particular a high content of the network formers SiO₂ and Al₂O₃, evidently results, namely, in a glass structure that can store stresses in an especially good manner. Although the content of Al₂O₃ in the glass reduces the number of the non-bridging oxygens in the glass network, nonetheless, in this case, a still adequate resistance to acids is achieved. It is thought that the reason for this lies in the interaction of the low absolute alkali content, in particular the low sodium oxide content, with the overall high content of network formers.

The prestressability can further be increased when the content of network formers in the glass or in the glass article is increased still further. However, the content of network formers in the glass or in the glass article is preferably limited. In accordance with one embodiment with the constituents of the composition otherwise further presently disclosed, the sum of the content of SiO₂ and Al₂O₃ is no more than 92 wt %, preferably no more than 90 wt %. Especially preferred, the total content of network formers in the glass or in the glass article is at most 92 wt %, most especially preferred at most 90 wt %. This is advantageous, because, in this way, a glass that is still meltable and consequently can be produced in an economical manner is obtained.

As discussed above, it is an important aspect of the prestressability that the alkali ions that are to be exchanged, that is, in particular the sodium ions in this case, also are present in an exchangeable form. However, this leads to conflicting goals, because a high mobility of the alkali ions can also lead to only a low chemical resistance, in particular to a low resistance of the glass or of the glass article to acids. For this reason, the content of alkali oxides in the glass or in the glass article should not be too high.

In accordance with one embodiment, the total content of alkali oxides in the glass and/or in the glass article is preferably at least 4 wt % and at most 12 wt %, preferably at most 10 wt %.

Li₂O is an optional component of the glass or of the glass article in accordance with the presently disclosed embodiments. Surprisingly, it has been found that, as a constituent of a glass or of a glass article, Li₂O also positively influences the prestressability or the prestressing of the glass or of the glass article even in the case when it itself does not take part in the ion exchange, that is, when only a potassium exchange occurs. This is ascribed to the fact that Li₂O is a component that supports the formation of a more rigid glass network, so that a content of Li₂O in the glass or in the glass article is preferred in accordance with one embodiment of the glass or of the glass article.

A content of Li₂O in the glass or in the glass article makes possible a mixed ion exchange, namely, in this case, an exchange for sodium ions. This can be preferred, because, in this way, it is possible to obtain chemically prestressable or chemically prestressed glass articles that have especially advantageous mechanical properties, such as, for example, for the load of the chemically prestressed glass article in a so-called set-drop test. In particular, the content in the glass or of the glass article in accordance with a preferred embodiment can be at least 3 wt %, preferably at least 3.5 wt %.

In accordance with a further embodiment of the glass article or of the glass, the content of Li₂O in the glass or in the glass article is accordingly preferably at least 3 wt %, especially preferred at least 3.5 wt %, and at most 5.5 wt %, preferably at most 5.0 wt %. This is advantageous, because, in the case of higher contents of Li₂O in the glass or in the glass article, an increased crystallization or an enhanced demixing of Li₂O can occur.

A further optional component of the glass or of the glass article is B₂O₃. A certain content of B₂O₃ in the glass can be advantageous, because this lowers the melting point of the glass and therefore improves the meltability. As is known, the component B₂O₃ also increases the scratch resistance of a glass. Surprisingly, however, it has been found that too high a content of B₂O₃ in the glass or in the glass article diminishes the prestressability. In accordance with one embodiment containing the otherwise presently disclosed additional composition percentages, the content of B₂O₃ in the glass and/or in the glass article is therefore at most 7 wt %, preferably at most 5 wt %, and especially preferred at most 4.5 wt %.

P₂O₅ is a further, optional component of the glass and/or of the glass article in accordance with the presently disclosed embodiments. A content of P₂O₅ in the glass and/or in the glass article can be advantageous, since, as a glass component, P₂O₅ can bring about the achievement of a deeper prestressing in a shorter time. P₂O₅ can also be advantageous, since, in this way, the exchange process can be accelerated. However, a high content of P₂O₅ in the glass is unfavorable, since P₂O₅ can attack the material of the melting apparatus. The content of the glass and/or of the glass article in accordance with embodiments should therefore be at most 3 wt %, preferably at most 2 wt % and especially preferred at most 1.7 wt %.

In accordance with another embodiment of the chemically prestressed or chemically prestressable, plate-shaped glass article, it comprises a glass comprising the following components in wt %:

| | |
|---|---|
| SiO₂ | 57 to 69, preferably 59 to 69, especially preferred 61 to 69, |
| | where the upper limit in each case can be preferably 67, |
| Al₂O₃ | 17 to 25, preferably 17 to 24, especially preferred 17 to 21, |
| B₂O₃ | 0 to 7, preferably 0 to 5, especially preferred 0 to 4.5, |
| Li₂O | 3 to 5.5, preferably 3.5 to 5.5, especially preferred 3.5 to 5, |
| Na₂O | 0.8 to 6, preferably 0.8 to 5.5, or even more preferred from |
| | 0.8 to 4.5, |

where preferably the sum of the content of Al₂O₃ and SiO₂, in relation to
the given value in wt %, lies between at least 75 and at most 92,
preferably at most 90.

The combination of the components in the aforementioned way provides a glass article that, surprisingly, is formed in an especially highly chemically prestressable manner or is chemically highly prestressed and thereby exhibits an adequate resistance to acids with, at the same time, a good meltability. It is suspected that the reason for this lies in the interaction of a small content of an alkali having a low field strength in the glass or in the glass article, namely, in this case, Na₂O, with the aforementioned content of network formers in the glass or in the glass article. However, an adequate meltability can nonetheless be achieved by way of the content of alkali oxides in the glass, which, in this case, is at least 4 wt %. The high prestressability of the glass or of the glass article in accordance with this embodiment is presumably further increased by the content of Li₂O in the aforementioned limits, since, on account of the high field strength of the lithium ion in comparison to other network modifiers, the formation of a rigid glass network is supported in an advantageous manner. At the same time, the lithium ion is bound more strongly in the glass matrix than are other alkali ions, which can also improve the resistance to acids.

In accordance with one embodiment of the plate-shaped glass article, it has a thickness of between at least 0.4 mm and at most 3 mm, with the thickness preferably being at least 0.5 mm and/or preferably being at most 2.0 mm, preferably at most 1.0 mm.

The glass article in accordance with the embodiments of the present disclosure has a resistance to acids that is determined as the half weight loss per unit area in mg/dm² in a test based on or in accordance with DIN 12116 and that is no more than 15 mg/dm². The half weight loss per unit area for the glass and/or for the glass article in accordance with embodiments is therefore no more than 15 mg/dm².

A second aspect of the present disclosure relates to a glass article, in particular a glass article in accordance with an embodiment in accordance with the present disclosure, in particular in accordance with the first aspect of the present disclosure, that is obtained in a method comprising the following steps: an optional first ion exchange in an exchange bath comprising between at least 20 wt % and up to 100 wt % of a sodium salt, preferably sodium nitrate NaNO₃, is carried out for a period of time of at least 2 hours, preferably at least 4 hours, and at most 24 hours at a temperature that lies between at least 380° C. and at most 440° C., whereby, optionally, a potassium salt, in particular potassium nitrate, can be added to the exchange bath, in particular such that the sum of the content of sodium salt and potassium salt adds up to 100 wt %, as well as an ion exchange in an exchange bath comprising between 0 wt % and 10 wt % of a sodium salt, preferably sodium nitrate NaNO₃, in relation to the total amount of the salt, for a period of time of at least one hour and at most 6 hours at a temperature of the exchange bath of at least 380° C. and at most 440° C., whereby a potassium salt is added to the exchange bath, in particular preferably potassium nitrate KNO₃, in particular such that the sum of the content of sodium salt and potassium salt adds up to 100 wt %, as well as, optionally, one further exchange step or a plurality of further exchange steps.

This means that, insofar as an ion exchange of sodium for lithium takes place, that is, an ion exchange in an exchange bath comprising between at least 20 wt % and up to 100 wt % of a sodium salt, this occurs as the first step. However, this step is merely optional, that is, need not necessarily be carried out.

Necessary, however, is the step of an ion exchange of potassium for sodium, that is, in an exchange bath comprising between 0 wt % and 10 wt % of a sodium salt, preferably sodium nitrate NaNO₃, in relation to the total amount of the salt, whereby a potassium salt is added to the exchange bath, in particular preferably potassium nitrate KNO₃, in particular such that the sum of the content of sodium salt and potassium salt adds up to 100 wt %.

A third aspect of the present disclosure relates to a glass comprising the following components in wt %:

| | |
|---|---|
| SiO₂ | 57 to 69, preferably 59 to 69, especially preferred 61 to 69, |
| | where the upper limit in each case can be preferably be 67, |
| Al₂O₃ | 17 to 25, preferably 17 to 24, especially preferred 17 to 21, |
| B₂O₃ | 0 to 7, preferably 0 to 5, especially preferred 0 to 4.5, |
| Li₂O | 3 to 5.5, preferably 3.5 to 5.5, especially preferred 3.5 to 5, |
| Na₂O | 0.8 to 6, preferably 0.8 to 5.5, especially preferred 0.8 to 4.5, |

where preferably the sum of the content of Al₂O₃ and SiO₂, in relation to
the given value in wt %, lies between at least 75 and at most 92,
preferably at most 90, and/or where preferably the total content of
alkali oxides in the glass and/or in the glass article is preferably
at least 4 wt % and at most 12 wt %, preferably at most 10 wt %.

As discussed above, what is involved here is a glass that has an especially good prestressability, which can be understood, for example, as a property of readily storing prestresses in the glass network and/or as an ability of the glass to make possible, together with, at the same time, a good resistance to acids, a good exchangeability of the alkali ions that are present, in particular of the sodium ions. In particular, this property of the glass can also be expressed as a prestressing or at least as a prestressability in relation to the weight percent of Na2O in the glass or in the glass article, of at least 250 MPa/g Na₂O in relation to an amount of 100 g of glass. Preferably, the prestressability is at most 1500 MPa/g Na₂O, especially preferred at most 1000 MPa/g Na₂O, in relation to an amount of 100 g of glass.

The present disclosure relates, furthermore, to a method for producing a glass article, preferably a glass article in accordance with embodiments of the present disclosure, comprising the steps:

an optional first ion exchange in an exchange bath comprising between at least 20 wt % and up to 100 wt % of a sodium salt, preferably sodium nitrate NaNO₃, is carried out for a period of time of at least 2 hours, preferably at least 4 hours, and at most 24 hours at a temperature that lies between at least 380° C. and at most 440° C., whereby, optionally, a potassium salt, in particular potassium nitrate, can be added to the exchange bath, in particular such that the sum of the content of sodium salt and potassium salt adds up to 100 %,

as well as an ion exchange in an exchange bath comprising between 0 wt % and 10 wt % of a sodium salt, preferably sodium nitrate NaNO₃, in relation to the total amount of the salt, for a period of time of at least one hour and at most 6 hours at a temperature of the exchange bath of at least 380° C. and at most 440° C., whereby a potassium salt is added to the exchange bath, in particular preferably potassium nitrate KNO₃, in particular such that the sum of the content of sodium salt and potassium salt adds up to 100 wt %, as well as, optionally, one further exchange step or a plurality of further exchange steps.

As already explained above, this means that, insofar as an ion exchange of sodium for lithium takes place, that is, an ion exchange in an exchange bath comprising between at least 20 wt %, and up to 100 wt % of a sodium salt, this occurs as a first step. However, this step is merely optional, that is, need not necessarily be carried out.

Necessary, however, is the step of an ion exchange of potassium for sodium, that is, in an exchange bath comprising between 0 wt % and 10 wt % of a sodium salt, preferably sodium nitrate NaNO₃, in relation to the total amount of the salt, whereby a potassium salt is added to the exchange bath, in particular preferably potassium nitrate KNO₃, in particular in the form that the sum of the content of sodium salt and potassium salt adds up to 100 wt %.

A further aspects relates thus to a glass article, produced or producible in a method according to embodiments of the present disclosure and/or comprising a glass according to the third aspect of the disclosure.

A yet further aspect of the disclosure is directed towards a use of the glass article according to embodiments, as a cover panel, in particular as a cover panel for devices in consumer electronics, in particular for display devices, monitors for computing devices, measurement devices, TV-devices, in particular as cover panel for mobile devices, in particular for at least one device of the group comprising: mobile terminals, mobile data processing devices, such as mobile phones, mobile computers, palm tops, laptops, tablet computers, wearables, portable watches and time measuring devices, or as a protective glass, in particular as a protective glass for machines, or as a glazing in high-speed trains, or as safety glass, or as automobile glazing, or in diving watches, or in submarines, or as a cover panel for explosion-protected devices, in particular for those in which the use of glass is mandatory.

### EXAMPLES

An exemplary range of composition of a glass is given by the following composition in wt %:

| | |
|---|---|
| SiO₂ | 57 to 69, preferably 59 to 69, especially preferred 61 to 69, |
| | where the upper limit in each case can be preferably 67, |
| Al₂O₃ | 17 to 25, preferably 17 to 24, especially preferred 17 to 21, |
| B₂O₃ | 0 to 7, preferably 0 to 5 especially preferred 0 to 4.5, |
| Li₂O | 3 to 5.5, preferably 3.5 to 5.5 especially preferred 3.5 to 5, |
| Na₂O | 0.8 to 6, preferably 0.8 to 5.5, especially preferred 0.8 to 4.5, |
| K₂O | 0 to 1, preferably 0 to 0.8, especially preferred 0 to 0.7, |
| MgO | 0 to 2, preferably 0 to 1.5, especially preferred 0 to 1, |
| CaO | 0 to 4.5, |
| SrO | 0 to 2, preferably 0 to 1.5, especially preferred 0 to 1, |
| ZnO | 0 to 3, preferably 0 to 2, especially preferred 0 to 1.5, |
| P₂O₅ | 0 to 3, preferably 0 to 2, especially preferred 0 to 1.7, |
| ZrO₂ | 0 to 3, preferably 0 to 2.8, especially preferred 0-2.5 and |
| | most especially preferred 0 to 1, |

where, furthermore, contaminants and/or refining agents and/or coloring
constituents can be present in amounts of up to 2 wt %.

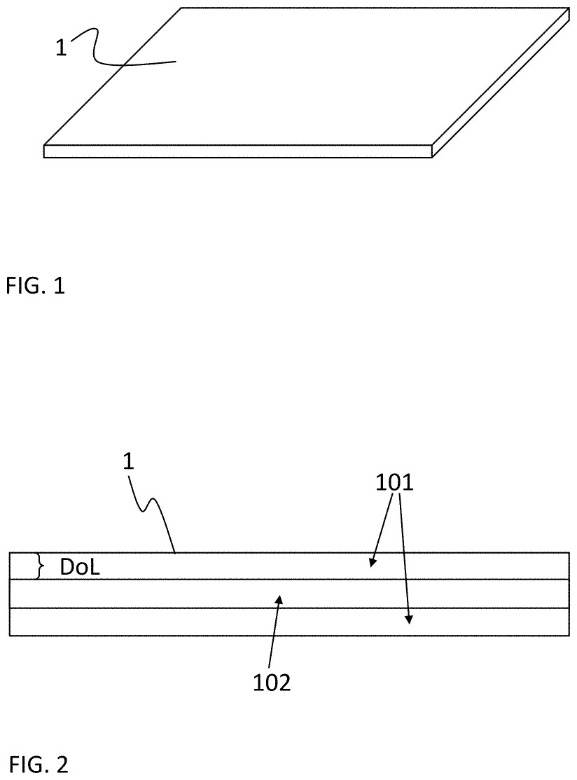

FIG. 1 is the schematic and not dimensionally accurate illustration of a plate-shaped glass article in accordance with the presently disclosed embodiments.

FIG. 2 shows a schematic and not dimensionally accurate sectional illustration of a glass article 1 in accordance with the presently disclosed embodiments. In this case, the glass article 1 has two zones 101 that are arranged on the two main surfaces of the glass article and are under compressive stress and may also be referred to as zones of compressive stress. These zones of compressive stress 101 have the dimension “DoL,” likewise drawn schematically in FIG. 2. For reasons of simplicity and clarity of the illustration, zones of compressive stress at the lateral edge of the main surfaces, which may be present there and may extend perpendicular to the main surface, are not illustrated in the figures. It is possible that the DoL on the two sides of the plate-shaped glass article differ in terms of their size, whereby, however, these differences lie, as a rule, within the limits of the measurement accuracy, so that the DoL for a plate-shaped glass article 1, is the same on both sides—at least within the limits of measurement accuracy.

Between the zones of compressive stress 101, there lies the region 102, which is under tensile stress.

### LIST OF REFERENCE NUMBERS

1 plate-shaped glass article

101 zone of compressive stress

102 inner region of the glass article under tensile stress

1. A chemically prestressed or chemically prestressable, plate-shaped or disc-shaped glass article, comprising:
a glass with a composition comprising Al₂O₃, SiO₂, Na₂O, and Li₂O, wherein the Na₂O is present in a weight percent between at least 0.8 and at most 6; and
a prestressing or a prestressability in relation to the weight percent of Na₂O of at least 250 MPa/g Na₂O in 100 g of glass.

2. The glass article of claim 1, wherein the Na₂O is at most 4.5 wt %.

3. The glass article of claim 1, wherein the prestressing or prestressability is at most 1000 MPa/g Na₂O.

4. The glass article of claim 1, wherein the prestressing or prestressability is at most 1500 MPa/g Na₂O.

5. The glass article of claim 1, wherein the composition comprises at least 57 wt % SiO₂ and at most 69 wt % SiO₂.

6. The glass article of claim 1, wherein the composition comprises at least 17 wt % Al₂O₃ and at most 24 wt % Al₂O₃.

7. The glass article of claim 1, wherein the composition comprises a sum of content of SiO₂ and Al₂O₃ that is no more than 92 wt %.

8. The glass article of claim 1, wherein the composition comprises a total content of network formers that is at most 92 wt %.

9. The glass article of claim 1, wherein the composition comprises a total content of alkali oxides that is at least 4 wt % and at most 12 wt %.

10. The glass article of claim 1, wherein the composition comprises at least 3 wt % Li₂O and at most 5.5 wt % Li₂O.

11. The glass article of claim 1, wherein the composition comprises at most 7 wt % B₂O₃.

12. The glass article of claim 1, wherein the composition comprises, in wt %:

| | |
|---|---|
| SiO₂ | 57 to 69, |
| Al₂O₃ | 17 to 25, |
| Li₂O | 3 to 5.5, |
| Na₂O | 0.8 to 6, and |

a sum of a content of Al₂O₃ and SiO₂ lies between at least 75 and
at most 92.

13. The glass article of claim 12, wherein the composition comprises:

| | |
|---|---|
| SiO₂ | 61 to 69, |
| Al₂O₃ | 17 to 21, |
| Li₂O | 3.5 to 5.5, and |
| Na₂O | 0.8 to 6. |

14. The glass article of claim 1, further comprising a thickness between at least 0.4 mm and at most 3 mm.

15. The glass article of claim 1, further comprising an acid resistance determined as a half weight loss per unit area in mg/dm²in a test in accordance with DIN 12116 that is no more than 15 mg/dm².

16. The glass article of claim 1, wherein the glass article is configured for a use selected from a group consisting of a cover panel, a cover panel for a consumer electronic device, a cover panel for a display device, a cover panel for a computer monitor, a cover panel for a measurement device, a cover panel for a television, a cover panel for a mobile device, a cover panel for a mobile terminal, a cover panel for a mobile data processing device, a cover panel for a mobile phone, a cover panel for a mobile computer, a cover panel for a palm top, a cover panel for a laptop, a cover panel for a tablet computer, a cover panel for a wearable device, a cover panel for a portable watch, a cover panel for a time measuring device, a protective glass for a machine, a glazing for a high-speed train, safety glass, an automobile glazing, a diving watch, a submarine, and a cover panel for an explosion-protected device.

17. A glass comprising a composition, in wt. %, of:

| | |
|---|---|
| SiO₂ | 57 to 69, |
| Al₂O₃ | 17 to 25, |
| B₂O₃ | 0 to 7, |
| Li₂O | 3 to 5.5, |
| Na₂O | 0.8 to 6, and |

a sum of a content of Al₂O₃ and SiO₂ lies between at least 75 and
at most 92.

18. The glass of claim 17, wherein the composition comprises:

| | |
|---|---|
| SiO₂ | 61 to 67, |
| Al₂O₃ | 17 to 21, |
| B₂O₃ | 0 to 4.5, |
| Li₂O | 3.5 to 5.5, and |
| Na₂O | 0.8 to 4.5. |

19. The glass of claim 17, wherein the glass is a chemically prestressed, plate-shaped or disc-shaped glass article.

20. A method for producing a glass article, comprising:
providing a glass comprising a composition, in wt. %, of: SiO₂ 57 to 69, Al₂O₃ 17 to 25, B₂O₃ 0 to 7, Li₂O 3 to 5.5, Na₂O 0.8 to 6, and a sum of a content of Al₂O₃ and SiO₂ lies between at least 75 and at most 92; and
conducting a first ion exchange between the glass and a first exchange bath comprising between at least 20 wt. % and up to 100 wt. % of sodium nitrate for a duration of at least 2 hours and at most 24 hours at a temperature of the first exchange bath of between at least 380° C. and at most 440° C.

21. The method of claim 20, further comprising conducting a second ion exchange in a second exchange bath comprising between 0 wt. % and 10 wt. % of sodium nitrate for a duration of at least one hour and at most 6 hours at a temperature of the second exchange bath of at least 380° C. and at most 440° C.

22. The method of claim 21, further comprising adding the sodium nitrate to the first exchange bath to provide the second exchange bath.
